(19) United States
(12) Patent Application Publication
(10) Pub. No.: US 2026/0079006 A1
(43) Pub. Date: Mar. 19, 2026

(54) CIRCUIT DEVICE AND PHYSICAL QUANTITY DETECTION DEVICE

(71) Applicant: SEIKO EPSON CORPORATION, Tokyo (JP)

(72) Inventors: Yuto Goi, Matsumoto-shi (JP); Hideo Haneda, Shiojiri-shi (JP)

(21) Appl. No.: 19/329,167

(22) Filed: Sep. 15, 2025

(30) Foreign Application Priority Data
Sep. 17, 2024 (JP) 2024-160015

(51) Int. Cl. G01C 19/5776

(52) U.S. Cl. CPC G01C 19/5776

(57) ABSTRACT

A circuit device includes a physical quantity detection signal outputting circuit including a first amplifier that receives a first signal output from a physical quantity detection element detecting a physical quantity and outputs a first amplified signal obtained by amplifying the first signal, a second amplifier that receives a second signal output from the physical quantity detection element and outputs a second amplified signal obtained by amplifying the second signal, and a differential amplifier circuit that outputs a differential amplified signal obtained by amplifying a difference between the first amplified signal and the second amplified signal, the physical quantity detection signal outputting circuit outputting a physical quantity detection signal corresponding to the physical quantity based on the differential amplified signal, and an in-phase feedback circuit that detects an in-phase signal component included in the first amplified signal and the second amplified signal, and outputs a feedback signal based on a detection signal of the in-phase signal component to the first amplifier and the second amplifier.

The present application is based on, and claims priority from JP Application Serial Number 2024-160015, filed Sep. 17, 2024, the disclosure of which is hereby incorporated by reference herein in its entirety.

### BACKGROUND

### 1. Technical Field

The present disclosure relates to a circuit device and a physical quantity detection device.

### 2. Related Art

Recently, in various systems and electronic apparatuses, physical quantity detection devices capable of detecting various physical quantities, such as a gyro sensor for detecting an angular velocity and an acceleration sensor for detecting an acceleration, are widely used. For example, JP-A-2021-185357 describes a physical quantity detection device in which AC charges generated in two detection electrodes of a physical quantity detection element are converted into voltages by a Q/V conversion circuit, and a digital signal having a digital value corresponding to a magnitude of an angular rate component is generated and output by a variable gain amplifier, a detection circuit, an active filter, and an analog/digital conversion circuit in a subsequent stage.

Here, in the physical quantity detection device described in JP-A-2021-185357, in addition to AC charges input by a differential manner, unnecessary signals of the same phase component generated by resonance of the physical quantity detection element may be input to the Q/V conversion circuit. However, since the Q/V conversion circuit is single-ended and has the same sensitivity with respect to all inputs, it is necessary to secure a sufficient output range so that a voltage output from the Q/V conversion circuit is not saturated. On the other hand, in order to increase the detection accuracy of a physical quantity, it is preferable to increase the sensitivity by increasing the gain of the Q/V conversion circuit. However, since the output range and the sensitivity of the Q/V conversion circuit have a trade-off relationship, it is necessary to lower the sensitivity in order to sufficiently secure the output range, and there is a problem in that it is difficult to detect the physical quantity with high accuracy.

### SUMMARY

A circuit device according to an aspect of the present disclosure includes a physical quantity detection signal outputting circuit including a first amplifier that receives a first signal output from a physical quantity detection element detecting a physical quantity and outputs a first amplified signal obtained by amplifying the first signal, a second amplifier that receives a second signal output from the physical quantity detection element and outputs a second amplified signal obtained by amplifying the second signal, and a differential amplifier circuit that outputs a differential amplified signal obtained by amplifying a difference between the first amplified signal and the second amplified signal, the physical quantity detection signal outputting circuit outputting a physical quantity detection signal corresponding to the physical quantity based on the differential amplified signal, and an in-phase feedback circuit that detects an in-phase signal component included in the first amplified signal and the second amplified signal, and outputs a feedback signal based on a detection signal of the in-phase signal component to the first amplifier and the second amplifier.

A physical quantity detection device according an aspect of the present disclosure includes the circuit device according to the aspect and the physical quantity detection element.

### BRIEF DESCRIPTION OF THE DRAWINGS

FIG. 1 is a functional block diagram of a physical quantity detection device.

FIG. 2 is a plan view of a resonator element of a physical quantity detection element.

FIG. 3 is a diagram illustrating an example of a configuration of a drive circuit.

FIG. 4 is a diagram illustrating an example of a configuration of a detection circuit.

FIG. 5 is a diagram illustrating an example of a configuration of an in-phase feedback circuit in a first embodiment.

FIG. 6 is a diagram illustrating an example of a configuration of an in-phase feedback circuit in a second embodiment.

FIG. 7 is a diagram illustrating another example of a configuration of the in-phase feedback circuit in the second embodiment.

FIG. 8 is a diagram illustrating another example of a configuration of the in-phase feedback circuit in the second embodiment.

FIG. 9 is a diagram illustrating another example of a configuration of the in-phase feedback circuit in the second embodiment.

FIG. 10 is a diagram illustrating an example of a configuration of an in-phase feedback circuit in a third embodiment.

FIG. 11 is a diagram illustrating an example of a configuration of an in-phase feedback circuit in a fourth embodiment.

### DESCRIPTION OF EMBODIMENTS

Hereinafter, preferred embodiments of the present disclosure will be described in detail with reference to the drawings. It should be noted that the embodiments described below do not unduly limit the contents of the present disclosure described in the appended claims. In addition, all of the configurations described below are not necessarily essential components of the present disclosure.

A physical quantity detection device that detects an angular velocity as a physical quantity, that is, an angular velocity detection device, will be described below as an example.

### 1. First Embodiment

### 1-1. Configuration of Physical Quantity Detection Device

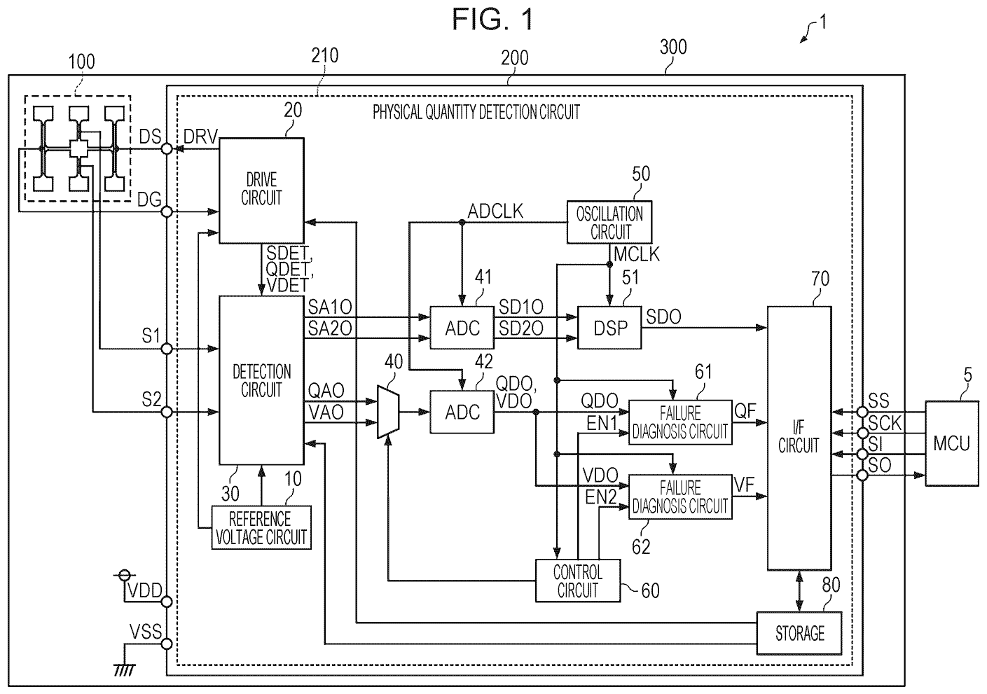

FIG. 1 is a functional block diagram illustrating a physical quantity detection device according to this embodiment. As shown in FIG. 1, a physical quantity detection device 1 of this embodiment includes a physical quantity detection element 100 that detects a physical quantity, a circuit device 200 including a physical quantity detection circuit 210, and a package 300 that houses the physical quantity detection element 100 that detects a physical quantity and the circuit device 200. The circuit device 200 is realized by, for example, a one-chip integrated circuit. The package 300 is, for example, a ceramic package.

The physical quantity detection element 100 includes a resonator element in which a drive electrode and a detection electrode are disposed. In general, the resonator element is sealed in a package in which airtightness is secured in order to increase oscillation efficiency by reducing an impedance of the resonator element as much as possible. In this embodiment, the physical quantity detection element 100 includes a so-called double T-shaped resonator element having two T-shaped drive vibration arms.

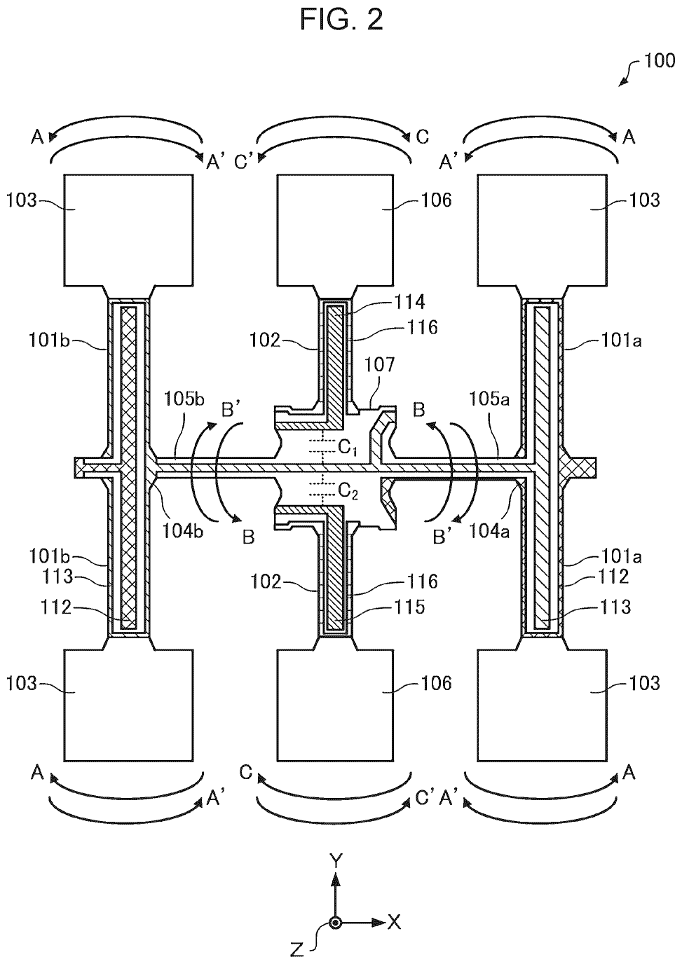

FIG. 2 is a plan view of the resonator element of the physical quantity detection element 100 according to this embodiment. The physical quantity detection element 100 includes, for example, a double T-shaped resonator element formed of a Z-cut quartz crystal substrate. The resonator element made of quartz crystal has an advantage in that the accuracy of detecting an angular velocity can be improved because a resonance frequency does not change much with a change in temperature. Note that an X axis, a Y axis, and a Z axis in FIG. 2 indicate axes of the quartz crystal.

As illustrated in FIG. 2, in the resonator element of the physical quantity detection element 100, drive vibration arms 101a and 101b extend from two drive base portions 104a and 104b, respectively, in a +Y axis direction and a −Y axis direction. Drive electrodes 112 and 113 are formed on a side surface and an upper surface of the drive vibration arm 101a, respectively. The drive electrodes 113 and 112 are formed on a side surface and an upper surface of the drive vibration arm 101b, respectively. The drive electrode 112 is connected to a DG terminal of the circuit device 200 illustrated in FIG. 1 by a wiring line (not illustrated), and the drive electrode 113 is connected to a DS terminal of the circuit device 200 illustrated in FIG. 1.

The drive base portions 104a and 104b are coupled to a rectangular detection base portion 107 via coupling arms 105a and 105b, respectively, extending in a −X axis direction and a +X axis direction.

Detection vibration arms 102 extend from the detection base portion 107 in the +Y axis direction and the −Y axis direction. Detection electrodes 114 and 115 are formed on upper surfaces of the detection vibration arms 102, and common electrodes 116 are formed on side surfaces of the respective detection vibration arms 102. The detection electrodes 114 and 115 are connected to the detection circuit 30 via an S1 terminal and an S2 terminal of the circuit device 200 illustrated in FIG. 1, respectively. The common electrode 116 is grounded.

When an alternating-current voltage is applied as a drive signal DRV between the drive electrodes 112 and 113 of the drive vibration arms 101a and 101b, distal ends of the two drive vibration arms 101a and 101b perform flexural vibration in which the distal ends repeatedly approach and move away from each other in an A direction and an A′ direction due to an inverse piezoelectric effect. Hereinafter, the flexural vibration of the drive vibration arms 101a and 101b may be also referred to as “excitation vibration”.

In this state, when an angular velocity with a Z axis as a rotational axis is applied to the resonator element of the physical quantity detection element 100, the drive vibration arms 101a and 101b obtain the Coriolis force in a direction orthogonal to both a direction of the flexural vibration and the Z axis. As a result, the two coupling arms 105a and 105b vibrate in a B direction and a B′ direction which are opposite to each other. In this case, the two detection vibration arms 102 attempt to maintain balance, and thus perform flexural vibration in a C direction and a C′ direction which are opposite to each other. A phase of the flexural vibration of each of the detection vibration arms 102 due to the Coriolis force is shifted by 90° from a phase of the flexural vibration of each of the drive vibration arms 101a and 101b due to the Coriolis force.

Then, AC charges based on these flexural vibrations are generated in the detection electrodes 114 and 115 of the detection vibration arms 102 due to a piezoelectric effect. In this case, the AC charges generated based on the Coriolis force vary depending on a magnitude of the Coriolis force, that is, a magnitude of an angular velocity applied to the physical quantity detection element 100.

Rectangular weight portions 103 that are wider than the drive vibration arms 101a and 101b are formed at the distal ends of the drive vibration arms 101a and 101b. Since the weight portions 103 are formed at the distal ends of the drive vibration arms 101a and 101b, the Coriolis force can be increased and a desired resonance frequency can be obtained with the relatively short vibration arms. Similarly, weight portions 106 that are wider than the detection vibration arms 102 are formed at distal ends of the detection vibration arms 102. Since the weight portions 106 are formed at the distal ends of the detection vibration arms 102, it is possible to increase amounts of AC charges generated in the detection electrodes 114 and 115.

Note that an alternating-current frequency component included in a drive signal DRV supplied to the drive electrodes 113 propagate to the detection electrodes 114 and 115 through a first electrostatic coupling capacitance C₁ present between the drive electrode 113 and the detection electrode 114 and a second electrostatic coupling capacitance C₂ present between the drive electrode 113 and the detection electrode 115, and AC charges based on the frequency components are generated, but the AC charges are not erroneously detected as an angular velocity as described below.

When magnitudes of vibration energies or magnitudes of vibration amplitudes obtained when the drive vibration arms 101a and 101b perform the flexural vibration are equal to each other between the two drive vibration arms 101a and 101b, the vibration energy of the drive vibration arm 101a and the vibration energy of the drive vibration arm 101b are balanced, and the detection vibration arms 102 do not perform flexural vibration in a state where an angular velocity is not applied to the physical quantity detection element 100. However, when the balance of the vibration energies of the two drive vibration arms 101a and 101b is lost, flexural vibration occurs in the detection vibration arms 102 even in a state where an angular velocity is not applied to the physical quantity detection element 100. This flexural vibration is referred to as leakage vibration and is flexural vibration in the C direction and the C′ direction similarly to vibration based on the Coriolis force, and AC charges based on the leakage vibration are generated in the detection electrodes 114 and 115. Since a phase of the leakage vibration is shifted by 90° from a phase of the vibration based on the Coriolis force, as will be described later, an AC charge is not erroneously detected as an angular velocity. However, in order to improve the accuracy of detecting an angular velocity, it is preferable that the leakage vibration does not occur.

For example, by tuning weights of the four weight portions 103 such that vibration energies of two portions of the drive vibration arm 101a are equal to each other, vibration energies of two portions of the drive vibration arm 101b are equal to each other, and a sum of the vibration energies of the two portions of the drive vibration arm 101a and a sum of the vibration energies of the two portions of the drive vibration arm 101b are equal to each other, it is possible to make substantially no leakage vibration occur. The weights of the weight portions 103 can be tuned by, for example, irradiating the weight portions 103 with a laser beam to remove portions of the weight portions 103. When the physical quantity detection element 100 is normal, substantially no leakage vibration occur. However, if the physical quantity detection element 100 fails, for example, if a crack or the like occurs in at least one of the drive vibration arms 101a and 101b and the detection vibration arms 102, the balance of the vibration energies of the drive vibration arms 101a and 101b is lost, and the leakage vibration occurs. Therefore, if the physical quantity detection element 100 fails, the physical quantity detection element 100 outputs AC charges based on the leakage vibration from the detection electrodes 114 and 115. As described above, the physical quantity detection element 100 is a double-T type gyro sensor element, and outputs, from the detection electrodes 114 and 115, AC charges based on the detected physical quantity, AC charges based on the drive signal DRV propagated through the first electrostatic coupling capacitance C₁ and the second electrostatic coupling capacitance C₂, and AC charges based on the leakage vibration. Hereinafter, the AC charges based on the physical quantity may be referred to as “physical quantity components”, the AC charges based on the drive signal DRV propagated through the first electrostatic coupling capacitance C₁ and the second electrostatic coupling capacitance C₂ may be referred to as “electrostatic leakage components”, and the AC charges based on the leakage vibration may be referred to as “vibration leakage components”. In this embodiment, a physical quantity detected by the physical quantity detection element 100 is an angular velocity based on the Coriolis force.

Returning to the description of FIG. 1, the physical quantity detection circuit 210 includes a reference voltage circuit 10, a drive circuit 20, a detection circuit 30, a selector 40, an analog/digital conversion circuit 41, an analog/digital conversion circuit 42, an oscillation circuit 50, a digital signal processing circuit 51, a control circuit 60, a failure diagnosis circuit 61, a failure diagnosis circuit 62, an interface circuit 70, and a storage 80. Note that the physical quantity detection circuit 210 may have a configuration in which some of these elements are omitted or changed, or other elements are additionally provided.

The reference voltage circuit 10 generates a constant voltage and a constant current, such as a reference voltage which is an analog ground voltage, based on a power supply voltage and a ground voltage which are supplied from a VDD terminal and a VSS terminal of the circuit device 200, respectively, and supplies the constant voltage and the constant current to the drive circuit 20 and the detection circuit 30.

The drive circuit 20 applies a drive signal DRV including a first frequency component for driving the physical quantity detection element 100 to the drive electrode 113 of the physical quantity detection element 100 through the DS terminal. The physical quantity detection element 100 is excited and vibrated by the drive signal DRV. In addition, an oscillation current generated in the drive electrodes 112 due to the excitation vibration of the physical quantity detection element 100 is input to the drive circuit 20 through the DG terminal, and the drive circuit 20 performs feedback control of an amplitude level of the drive signal DRV such that an amplitude of the oscillation current is kept constant. Furthermore, the drive circuit 20 generates a detection signal SDET having the same phase as the drive signal DRV, a detection signal QDET at a frequency twice a frequency of the detection signal SDET, and a detection signal VDET having a phase different from the phase of the drive signal DRV by 90°, and outputs the detection signals SDET, QDET, and VDET to the detection circuit 30.

The detection circuit 30 outputs physical quantity detection signals SA1O and SA2O corresponding to a physical quantity detected by the physical quantity detection element 100 based on a first physical quantity component included in a first signal output from the detection electrode 114 of the physical quantity detection element 100 and a second physical quantity component included in a second signal output from the detection electrode 115 of the physical quantity detection element 100. The first signal is an AC charge input via the S1 terminal of the circuit device 200, and the second signal is an AC charge input via the S2 terminal of the circuit device 200. The detection circuit 30 detects physical quantity components based on the first physical quantity component included in the first signal and the second physical quantity component included in the second signal using the detection signal SDET, and generates and outputs physical quantity detection signals SA1O and SA2O which are analog signals at voltage levels corresponding to magnitudes of the detected physical quantity components.

Furthermore, the detection circuit 30 outputs an electrostatic leakage detection signal QAO based on a first electrostatic leakage component included in the first signal and a second electrostatic leakage component included in the second signal. The drive signal DRV output from the drive circuit 20 includes a second frequency component at a frequency different from the frequency of the first frequency component, and the first electrostatic leakage component is a component of the second frequency component propagated to the detection electrode 114 through the first electrostatic coupling capacitance C₁ present between the drive electrodes 113 and the detection electrode 114 of the physical quantity detection element 100. Similarly, the second electrostatic leakage component is a component of the second frequency component propagated to the detection electrode 115 through the second electrostatic coupling capacitance C₂ present between the drive electrodes 113 and the detection electrode 115 of the physical quantity detection element 100. In this embodiment, a frequency of the second frequency component is twice the frequency of the first frequency component, and the second frequency component is generated when the drive circuit 20 generates the drive signal DRV, as will be described later. The detection circuit 30 detects an electrostatic leakage component based on the first electrostatic leakage component included in the first signal and the second electrostatic leakage component included in the second signal using the detection signal QDET, and generates and outputs an electrostatic leakage detection signal QAO which is an analog signal at a voltage level corresponding to a magnitude of the detected electrostatic leakage component.

Furthermore, the detection circuit 30 outputs a vibration leakage detection signal VAO based on a first vibration leakage component included in the first signal output from the detection electrode 114 of the physical quantity detection element 100 and a second vibration leakage component included in the second signal output from the detection electrode 115 of the physical quantity detection element 100. The first vibration leakage component and the second vibration leakage component are based on the vibration of the physical quantity detection element 100. As described above, when the physical quantity detection element 100 is normal, substantially no leakage vibration occurs, and thus the first signal includes substantially no first vibration leakage component, and the second signal includes substantially no second vibration leakage component. On the other hand, if the physical quantity detection element 100 fails, the leakage vibration occurs, and thus the first signal includes the first vibration leakage component and the second signal includes the second vibration leakage component. The detection circuit 30 detects a vibration leakage component based on the first vibration leakage component included in the first signal and the second vibration leakage component included in the second signal using the detection signal VDET, and generates and outputs the vibration leakage detection signal VAO which is an analog signal at a voltage level corresponding to a magnitude of the detected vibration leakage component.

The storage 80 includes a nonvolatile memory (not illustrated), and the nonvolatile memory stores various types of trimming data for the drive circuit 20 and the detection circuit 30. The nonvolatile memory may be configured as, for example, a MONOS type memory or an EEPROM. MONOS is an abbreviation for Metal Oxide Nitride Oxide Silicon. Furthermore, EEPROM is an abbreviation of Electrically Erasable Programmable Read-Only Memory. Furthermore, the storage 80 may include a register (not illustrated), and when the circuit device 200 is powered on, that is, when a voltage of the VDD terminals rises from Ov to a desired voltage, the various types of trimming data stored in the nonvolatile memory may be transferred to and held in the register, and the various types of trimming data held in the register may be supplied to the drive circuit 20 and the detection circuit 30.

The oscillation circuit 50 generates a master clock signal MCLK and supplies the master clock signal MCLK to the digital signal processing circuit 51 and the failure diagnosis circuits 61 and 62. In addition, the oscillation circuit 50 divides a frequency of the master clock signal MCLK to generate a clock signal ADCLK, and supplies the clock signal ADCLK to the analog/digital conversion circuits 41 and 42. The oscillation circuit 50 may generate the master clock signal MCLK by using, for example, a ring oscillator or a CR oscillation circuit.

The selector 40 selects the electrostatic leakage detection signal QAO and the vibration leakage detection signal VAO in a time-division manner according to a control signal output from the control circuit 60 and outputs the selected signals to the analog/digital conversion circuit 42.

The analog/digital conversion circuit 41 operates based on the clock signal ADCLK, converts the physical quantity detection signals SA1O and SA2O, which are analog signals output from the detection circuit 30, into physical quantity detection signals SD1O and SD2O, which are digital signals, respectively, and outputs the physical quantity detection signals SD1O and SD2O.

The analog/digital conversion circuit 42 operates based on the clock signal ADCLK, converts the electrostatic leakage detection signal QAO and the vibration leakage detection signal VAO, which are analog signals output from the selector 40 in a time-division manner, into an electrostatic leakage detection signal QDO and a vibration leakage detection signal VDO, which are digital signals, respectively, and outputs the electrostatic leakage detection signal QDO and the vibration leakage detection signal VDO.

The digital signal processing circuit 51 operates based on the master clock signal MCLK, performs predetermined calculation processing, such as difference calculation, on the physical quantity detection signals SD1O and SD2O output from the analog/digital conversion circuit 41, and outputs a physical quantity detection signal SDO obtained by the calculation processing.

The failure diagnosis circuit 61 operates based on the master clock signal MCLK, and performs failure diagnosis on the physical quantity detection device 1 based on the electrostatic leakage detection signal QDO. Then, the failure diagnosis circuit 61 outputs a failure flag QF indicating whether the physical quantity detection device 1 has failed. In the physical quantity detection device 1, the AC charge based on the drive signal DRV propagating to the detection electrodes 114 and 115 via the first electrostatic coupling capacitance C₁ and the second electrostatic coupling capacitance C₂ is constant. Therefore, when two wiring lines connecting the detection electrodes 114 and 115 and the S1 and S2 terminals of the circuit device 200 are normal, a value of the electrostatic leakage detection signal QDO is included in a predetermined first range. On the other hand, when at least one of the wiring line coupling the detection electrode 114 to the S1 terminal and the wiring line coupling the detection electrode 115 to the S2 terminal is decoupled, a value of the electrostatic leakage detection signal QDO deviates from the first range. Therefore, the failure diagnosis circuit 61 may diagnose that the physical quantity detection device 1 has failed when the value of the electrostatic leakage detection signal QDO is not in the first range. For example, the first range may be set to include a predetermined value which is assumed in design when the physical quantity detection device 1 is normal, and to include a range that may change from the predetermined value over time. In addition, the first range may be fixed or may be variable. For example, the first range may be variably set according to a value stored in the register which is included in the storage 80 and is rewritable from the outside of the circuit device 200.

The failure diagnosis circuit 62 operates based on the master clock signal MCLK and performs failure diagnosis on the physical quantity detection device 1 based on the vibration leakage detection signal VDO. Then, the failure diagnosis circuit 62 outputs a failure flag VF indicating whether the physical quantity detection device 1 has failed. When the physical quantity detection device 1 is normal, substantially no leakage vibration occurs, and thus a value of the vibration leakage detection signal VDO is in a predetermined second range. On the other hand, for example, when the physical quantity detection element 100 fails, for example, a portion of the physical quantity detection element 100 is broken, the leakage vibration occurs, and thus a value of the vibration leakage detection signal VDO deviates from the second range. Therefore, the failure diagnosis circuit 62 may diagnose that the physical quantity detection device 1 has failed when the value of the vibration leakage detection signal VDO is not in the second range. For example, the second range may be set to include a predetermined value which is assumed in design when the physical quantity detection device 1 is normal, and to include a range that may change from the predetermined value over time. In addition, the second range may be fixed or may be variable. For example, the second range may be variably set according to a value stored in the register which is included in the storage 80 and is rewritable from the outside of the circuit device 200.

The control circuit 60 operates based on the master clock signal MCLK, and generates a control signal for controlling the operation of the selector 40 and enable signals EN1 and EN2 for operating the respective failure diagnosis circuits 61 and 62. Specifically, the control circuit 60 causes the failure diagnosis circuit 61 to operate by activating the enable signal EN1 only in a period of time when the analog/digital conversion circuit 42 outputs the electrostatic leakage detection signal QDO, and causes the failure diagnosis circuit 62 to operate by activating the enable signal EN2 only in a period of time when the analog/digital conversion circuit 42 outputs the vibration leakage detection signal VDO.

The interface circuit 70 performs a process of outputting the physical quantity detection signal SDO output from the digital signal processing circuit 51, the failure flags QF and VF, and the like to an MCU 5 in response to a request from the MCU 5 which is an external device of the circuit device 200. MCU is an abbreviation for Micro Control Unit. Note that the interface circuit 70 may perform a process of outputting, to the MCU 5, the electrostatic leakage detection signal QDO and the vibration leakage detection signal VDO output from the analog/digital conversion circuit 42 in response to a request from the MCU 5. In this case, the physical quantity detection circuit 210 does not necessarily include the failure diagnosis circuits 61 and 62, and the MCU 5 may perform the same failure diagnosis as that performed by the failure diagnosis circuits 61 and 62, based on the electrostatic leakage detection signal QDO and the vibration leakage detection signal VDO.

Furthermore, in response to a request from the MCU 5, the interface circuit 70 performs a process of reading data stored in the nonvolatile memory and the register of the storage 80 and outputting the data to the MCU 5, and a process of writing data input from the MCU 5 to the nonvolatile memory and the register of the storage 80. For example, the MCU 5 may perform a process of writing, to a predetermined register, values for setting the first range and the second range described above.

The interface circuit 70 is, for example, an interface circuit of an SPI bus, receives a selection signal, a clock signal, and a data signal transmitted from the MCU 5 via terminals SS, SCK, and SI of the circuit device 200, respectively, and outputs the data signal to the MCU 5 via a terminal SO of the circuit device 200. SPI is an abbreviation for Serial Peripheral Interface. Note that the interface circuit 70 may be an interface circuit corresponding to various buses other than the SPI bus, for example, an I²C bus. I²C is an abbreviation for Inter-Integrated Circuit.

In the physical quantity detection device 1 configured as described above according to this embodiment, the physical quantity detection element 100 outputs the first signal which is the AC charge generated in the detection electrode 114 and the second signal which is the AC charge generated in the detection electrode 115, and the physical quantity detection circuit 210 generates the physical quantity detection signal SDO corresponding to the physical quantity detected by the physical quantity detection element 100, based on the first signal and the second signal output from the physical quantity detection element 100. The physical quantity detection circuit 210 generates the failure flags QF and VF indicating the presence or absence of a failure of the physical quantity detection device 1 based on the first signal and the second signal output from the physical quantity detection element 100.

### 1-2. Configuration of Drive Circuit

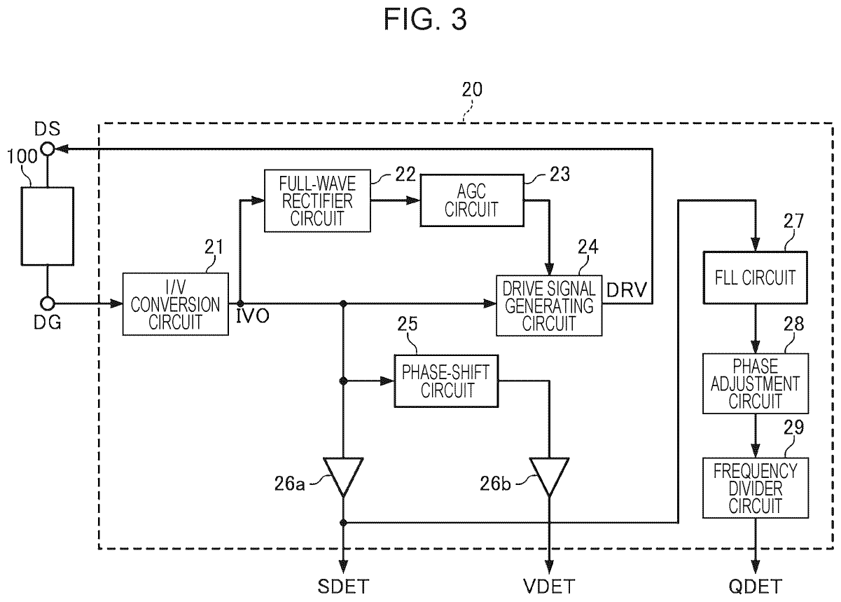

FIG. 3 is a diagram illustrating an example of a configuration of the drive circuit 20. As illustrated in FIG. 3, the drive circuit 20 includes a current/voltage conversion circuit 21, a full-wave rectifier circuit 22, an automatic gain control circuit 23, a drive signal generating circuit 24, a phase-shift circuit 25, a buffer circuit 26a, a buffer circuit 26b, an FLL circuit 27, a phase adjustment circuit 28, and a frequency divider circuit 29.

An oscillation current generated in the drive electrode 112 due to the excitation vibration of the physical quantity detection element 100 is input to the current/voltage conversion circuit 21 through the DG terminal, and is converted into an AC voltage signal IVO by the current/voltage conversion circuit 21. The AC voltage signal IVO output from the current/voltage conversion circuit 21 is input to the full-wave rectifier circuit 22, the drive signal generating circuit 24, the phase-shift circuit 25, and the buffer circuit 26a.

The full-wave rectifier circuit 22 performs full-wave rectification on the signal IVO output from the current/voltage conversion circuit 21 to form a DC signal and outputs the DC signal.

The automatic gain control circuit 23 amplifies the signal output from the full-wave rectifier circuit 22 to form a signal having a predetermined voltage and outputs the signal having the predetermined voltage. The automatic gain control circuit 23 controls a gain of amplification in accordance with a magnitude of the signal output from the full-wave rectifier circuit 22 such that the output signal is constant at a predetermined voltage.

The drive signal generating circuit 24 outputs a drive signal DRV obtained by binarizing the signal IVO output from the current/voltage conversion circuit 21. A high-level voltage of the drive signal DRV is a voltage of a signal output from the automatic gain control circuit 23, and is constant at a predetermined voltage. The drive signal DRV is supplied to the drive electrode 113 of the physical quantity detection element 100 through the DS terminal. The physical quantity detection element 100 can continue the excitation vibration while receiving the drive signal DRV. Furthermore, since the high-level voltage of the drive signal DRV is kept constant, the drive vibration arms 101a and 101b of the physical quantity detection element 100 can vibrate at a constant vibration speed. Therefore, a vibration speed which is a source of generating the Coriolis force can be constant, and the sensitivity can be made more stable.

A fundamental frequency of the drive signal DRV generated as described above matches a frequency f of the flexural vibration of each of the drive vibration arms 101a and 101b of the physical quantity detection element 100. In addition, the full-wave rectifier circuit 22 performs full-wave rectification to generate the second frequency component at a frequency 2f, and superimposes the second frequency component on the high-level voltage of the drive signal DRV. Therefore, the drive signal DRV includes the first frequency component at the frequency f and the second frequency component at the frequency 2f.

The phase-shift circuit 25 outputs a signal obtained by advancing a phase of the signal IVO output from the current/voltage conversion circuit 21 by 90°. The phase-shift circuit 25 may be an all-pass filter including an amplifier, a resistor, and a capacitor. The buffer circuit 26a outputs the detection signal SDET having the same phase as the signal IVO. The buffer circuit 26b outputs the detection signal VDET having the same phase as the signal output from the phase-shift circuit 25. Note that a filter may be provided between the output of the current/voltage conversion circuit 21 and the input of the buffer circuit 26a.

The FLL circuit 27 converts the detection signal SDET into a clock signal VCO at a frequency that is n times higher than that of the detection signal SDET, and outputs the clock signal VCO. FLL is an abbreviation for Frequency Locked Loop. The phase adjustment circuit 28 adjusts a phase of the clock signal VCO output from the FLL circuit 27 such that a rising edge of the clock signal VCO matches a rising edge of the detection signal SDET. The frequency divider circuit 29 divides the frequency of the clock signal VCO, and outputs the detection signal QDET at a frequency that is twice the frequency of the detection signal SDET.

The detection signal SDET is a square-wave voltage signal at the frequency f, the detection signal QDET is a square-wave voltage signal at the frequency 2f, and the detection signal VDET is a square-wave voltage signal at the frequency f and with a phase advanced by 90° from the phase of the detection signal SDET. The detection signals SDET, QDET, and VDET are supplied to the detection circuit 30.

### 1-3. Configuration of Detection Circuit

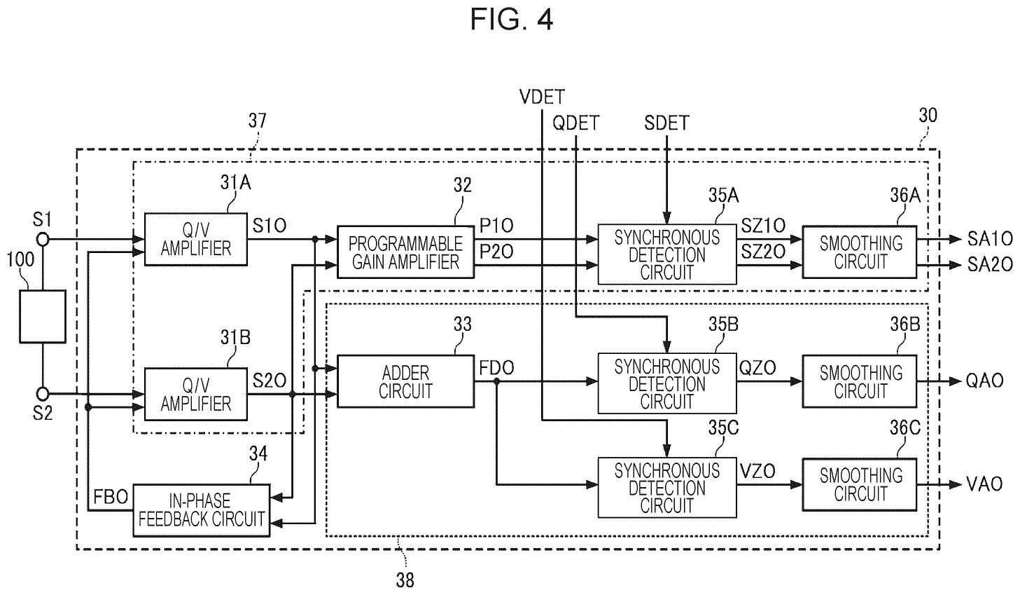

FIG. 4 is a diagram illustrating an example of a configuration of the detection circuit 30. As shown in FIG. 4, the detection circuit 30 includes a Q/V amplifiers 31A and 31B, a programmable gain amplifier 32, an adder circuit 33, an in-phase feedback circuit 34, synchronous detection circuits 35A to 35C, and smoothing circuits 36A to 36C.

The first signal is input to the Q/V amplifier 31A through the S1 terminal. As described above, the first signal is an AC charge generated in the detection electrode 114 of the physical quantity detection element 100, and includes the first physical quantity component and the first electrostatic leakage component.

The second signal is input to the Q/V amplifier 31B through the S2 terminal. As described above, the second signal is an AC charge generated in the detection electrode 115 of the physical quantity detection element 100, and includes the second physical quantity component and the second electrostatic leakage component.

In this embodiment, as illustrated in FIG. 2, when an angular velocity is applied to the physical quantity detection element 100, the detection vibration arm 102 on which the detection electrode 114 is formed and the detection vibration arm 102 on which the detection electrode 115 is formed perform flexural vibration in opposite directions to each other so as to be balanced. Therefore, the first physical quantity component included in the first signal and the second physical quantity component included in the second signal have phases opposite to each other. Here, the case where the first physical quantity component included in the first signal and the second physical quantity component included in the second signal have phases opposite to each other includes not only a case where the difference between the phases of the two physical quantity components is exactly 180° but also a case where the difference between the phases of the two physical quantity components is slightly different from 180° due to a manufacturing error of the physical quantity detection element 100, an error of a delay time of a signal propagation path, or the like.

In this embodiment, the phase of the first electrostatic leakage component included in the first signal and the phase of the second electrostatic leakage component included in the second signal are the same. The case where the phase of the first electrostatic leakage component included in the first signal and the phase of the second electrostatic leakage component included in the second signal are the same includes not only a case where the difference between the phases of the two electrostatic leakage components is accurately 0° but also a case where the difference between the phases of the two electrostatic leakage components is slightly different from 0° due to a manufacturing error of the physical quantity detection element 100, an error of a delay time of the signal propagation path, or the like.

If the physical quantity detection element 100 fails, the first signal further includes the first vibration leakage component, and the second signal further includes the second vibration leakage component. In this embodiment, if the physical quantity detection element 100 fails, the phase of the first vibration leakage component included in the first signal and the phase of the second vibration leakage component included in the second signal are the same. The case where the phase of the first vibration leakage component included in the first signal and the phase of the second vibration leakage component included in the second signal are the same includes not only a case where the difference between the phases of the two vibration leakage components is accurately 0° but also a case where the difference between the phases of the two vibration leakage components is slightly different from 0° due to a manufacturing error of the physical quantity detection element 100, an error of a delay time of the signal propagation path, or the like.

The Q/V amplifier 31A amplifies the first signal input from the detection electrode 114 of the physical quantity detection element 100, and the Q/V amplifier 31B amplifies the second signal input from the detection electrode 115 of the physical quantity detection element 100. Specifically, the Q/V amplifier 31A converts the first signal into an AC voltage signal S1O based on a reference voltage V_{ref} generated by the reference voltage circuit 10 and outputs the AC voltage signal S1O, and the Q/V amplifier 31B converts the second signal into an AC voltage signal S2O based on the reference voltage V_{ref} and outputs the AC voltage signal S2O.

The programmable gain amplifier 32 receives a differential-signal pair including the signal S1O output from the Q/V amplifier 31A and the signal S2O output from the Q/V amplifier 31B, amplifies a difference between the signals S1O and S2O, and outputs a differential-signal pair including signals P1O and P2O.

Since the phase of the first vibration leakage component included in the first signal and the phase of the second vibration leakage component included in the second signal are the same, the vibration leakage components are attenuated by the programmable gain amplifier 32. Therefore, even if the physical quantity detection element 100 fails, an effect of the vibration leakage components on the physical quantity components is reduced in the signal output from the programmable gain amplifier 32. Note that, in the signal output from the programmable gain amplifier 32, in order to substantially eliminate the effect of the vibration leakage components on the physical quantity components, an amount of the difference between the first vibration leakage component and the second vibration leakage component is preferably substantially zero. The case where the amount of the difference between the first vibration leakage component and the second vibration leakage component is substantially zero includes not only a case where the amount of the difference is exactly zero but also a case where the amount of the difference is slightly different from zero due to a minimum adjustment resolution of the first vibration leakage component and the second vibration leakage component or the like and a case where a measured value of the amount of the difference is slightly different from zero due to a measurement error of the amount of the difference between the first vibration leakage component and the second vibration leakage component.

The synchronous detection circuit 35A performs synchronous detection on the signals P1O and P2O output from the programmable gain amplifier 32. Specifically, the synchronous detection circuit 35A performs synchronous detection on the signals P1O and P2O, as target detection signals, output from the programmable gain amplifier 32 based on the detection signal SDET, and outputs a differential signal pair including signals SZ1O and SZ2O. The synchronous detection circuit 35A extracts physical quantity components included in the signals P1O and P2O output from the programmable gain amplifier 32. The synchronous detection circuit 35A may be, for example, a switch circuit that selects the signal P1O as the signal SZ1O and the signal P2O as the signal SZ2O when a voltage level of the detection signal SDET is higher than the reference voltage V_{ref}, and selects the signal P2O as the signal SZ1O and the signal P1O as the signal SZ2O when a voltage level of the detection signal SDET is lower than the reference voltage V_{ref}.

The smoothing circuit 36A smooths the signals SZ1O and SZ2O output from the synchronous detection circuit 35A into DC voltage signals and outputs a differential signal pair including the DC voltage signals. The signals output from the smoothing circuit 36A are output from the detection circuit 30 as physical quantity detection signals SA1O and SA2O.

Note that the Q/V amplifier 31A is an example of a “first amplifier”, the Q/V amplifier 31B is an example of a “second amplifier”, and the programmable gain amplifier 32 is an example of a “differential amplifier circuit”. The signal S1O is an example of a “first amplified signal”, and the signal S2O is an example of a “second amplified signal”.

The Q/V amplifiers 31A and 31B, the programmable gain amplifier 32, the synchronous detection circuit 35A, and the smoothing circuit 36A constitute a physical quantity detection signal outputting circuit 37 that outputs the physical quantity detection signal SA1O and SA2O corresponding to the physical quantity detected by the physical quantity detection element 100. The physical quantity detection signal outputting circuit 37 amplifies a difference between the first signal and the second signal input from the detection electrodes 114 and 115 of the physical quantity detection element 100, respectively, by the Q/V amplifiers 31A and 31B and the programmable gain amplifier 32, performs synchronous detection on the signals P1O and P2O output from the programmable gain amplifier 32 based on the detection signal SDET, and outputs the physical quantity detection signals SA1O and SA2O based on the signals SZ1O and SZ2O obtained by the synchronous detection.

The adder circuit 33 outputs a signal FDO obtained by adding the signal S1O output from the Q/V amplifier 31A to the signal S2O output from the Q/V amplifier 31B. As described above, since the first physical quantity component included in the first signal and the second physical quantity component included in the second signal have the phases opposite to each other, the physical quantity components are attenuated by the adder circuit 33. On the other hand, since the phase of the first electrostatic leakage component included in the first signal and the phase of the second electrostatic leakage component included in the second signal are the same, the electrostatic leakage components are amplified by the adder circuit 33. Similarly, since the phase of the first vibration leakage component included in the first signal and the phase of the second vibration leakage component included in the second signal are the same, the vibration leakage components are amplified by the adder circuit 33.

The synchronous detection circuit 35B performs synchronous detection on the signal FDO output from the adder circuit 33. Specifically, the synchronous detection circuit 35B performs synchronous detection on the signal FDO output from the adder circuit 33, as a target detection signal, based on the detection signal QDET, and outputs a signal QZO. An electrostatic leakage component included in the signal FDO output from the adder circuit 33 is extracted by the synchronous detection circuit 35B. For example, the synchronous detection circuit 35B may be a switch circuit that selects, as the signal QZO, the signal FDO output from the adder circuit 33 when a voltage level of the detection signal QDET is higher than the reference voltage V_{ref}, and selects a signal obtained by inverting the signal FDO output from the adder circuit 33 with respect to the reference voltage V_{ref} when a voltage level of the detection signal QDET is lower than the reference voltage V_{ref}.

The smoothing circuit 36B smooths the signal QZO output from the synchronous detection circuit 35B into a DC voltage signal. The signal output from the smoothing circuit 36B is output from the detection circuit 30 as the electrostatic leakage detection signal QAO.

The synchronous detection circuit 35C performs synchronous detection on the signal FDO, as a target detection signal, output from the adder circuit 33 based on the detection signal VDET, and outputs a signal VZO. The synchronous detection circuit 35C extracts a vibration leakage component included in the signal FDO output from the adder circuit 33. For example, the synchronous detection circuit 35C may be a switch circuit that selects, as the signal VZO, the signal FDO output from the adder circuit 33 when a voltage level of the detection signal VDET is higher than the reference voltage V_{ref}, and selects a signal obtained by inverting the signal FDO output from the adder circuit 33 with respect to the reference voltage V_{ref} when a voltage level of the detection signal VDET is lower than the reference voltage V_{ref}.

The smoothing circuit 36C smooths the signal VZO output from the synchronous detection circuit 35C into a DC voltage signal. The signal output from the smoothing circuit 36C is output from the detection circuit 30 as the vibration leakage detection signal VAO.

In this way, the synchronous detection circuits 35B and 35C and the smoothing circuits 36B and 36C output the electrostatic leakage detection signal QAO and the vibration leakage detection signal VAO based on the signal FDO output from the adder circuit 33. That is, the adder circuit 33, the synchronous detection circuits 35B and 35C, and the smoothing circuits 36B and 36C constitute a failure diagnostic signal outputting circuit 38 which outputs the electrostatic leakage detection signal QAO and the vibration leakage detection signal VAO which are failure diagnostic signals. The failure diagnostic signal outputting circuit 38 causes the synchronous detection circuit 35B to perform synchronous detection on the signal FDO obtained by adding the signal S1O output from the Q/V amplifier 31A to the signal S2O output from the Q/V amplifier 31B by the adder circuit 33 based on the detection signal QDET, and outputs the electrostatic leakage detection signal QAO, which is the failure diagnostic signal, based on the signal QZO obtained by the synchronous detection. Furthermore, the failure diagnostic signal outputting circuit 38 causes the synchronous detection circuit 35C to perform synchronous detection on the signal FDO obtained by adding the signal S1O output from the Q/V amplifier 31A to the signal S2O output from the Q/V amplifier 31B by the adder circuit 33 based on the detection signal VDET, and outputs the vibration leakage detection signal VAO, which is the failure diagnostic signal, based on the signal VZO obtained by the synchronous detection.

In addition, the selector 40, the analog/digital conversion circuit 42, and the failure diagnosis circuits 61 and 62 illustrated in FIG. 1 function as a failure diagnosis circuit that performs failure diagnosis based on the electrostatic leakage detection signal QAO and the vibration leakage detection signal VAO, which are failure diagnostic signals, and outputs the failure flags QF and VF indicating a result of the diagnosis.

Incidentally, there is a case where the physical quantity detection element 100 resonates due to environmental vibration or the like, and large-amplitude, in-phase resonance signals are input to the Q/V amplifiers 31A and 31B. As a result, when voltages of the signals S1O and S2O output from the Q/V amplifiers 31A and 31B, respectively, are saturated, the physical quantity component is distorted or disappears, and the accuracy of the physical quantity detection signal SDO is reduced.

In order to prevent the voltages of the signals S1O and S2O from being saturated with respect to the input of such a resonance signal, it is considered that the sensitivity of the Q/V amplifiers 31A and 31B is lowered to widen the output range, but the S/N of the physical quantity detection signal SDO is lowered. Therefore, in this embodiment, the in-phase feedback circuit 34 is provided in order to prevent the voltages of the signals S1O and S2O from being saturated without reducing the detection accuracy of the physical quantity.

The in-phase feedback circuit 34 detects in-phase signal components included in the signals S1O and S2O, generates a feedback signal FBO based on a detection signal of the in-phase signal component, and outputs the feedback signal FBO to the Q/V amplifiers 31A and 31B.

### 1-4. Configuration of In-Phase Feedback Circuit

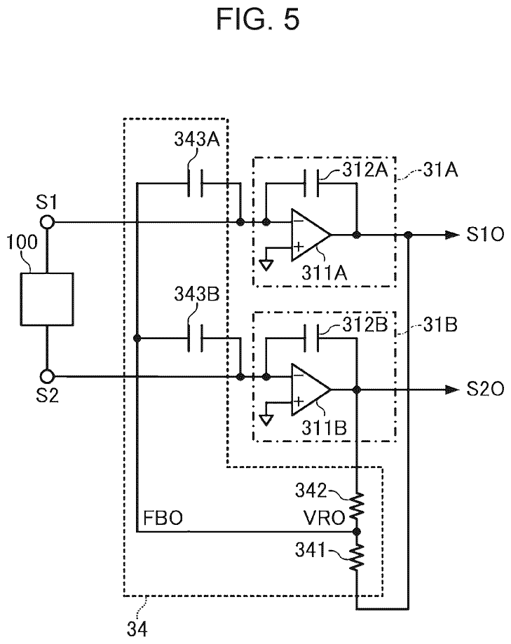

FIG. 5 is a diagram illustrating an example of a configuration of the in-phase feedback circuit 34. FIG. 5 also illustrates configurations of the Q/V amplifiers 31A and 31B.

As illustrated in FIG. 5, the Q/V amplifier 31A includes an operational amplifier 311A and a capacitor 312A, and accumulates, in the capacitor 312A, charges input from the detection electrode 114 of the physical quantity detection element 100 to an inverting input terminal of the operational amplifier 311A via the S1 terminal and converts the charges into a voltage. Similarly, the Q/V amplifier 31B includes an operational amplifier 311B and a capacitor 312B, and accumulates, in the capacitor 312B, charges input from the detection electrode 115 of the physical quantity detection element 100 to an inverting input terminal of the operational amplifier 311B via the S2 terminal and converts the charges into a voltage. To be more specific, the reference voltage V_{ref} is supplied to non-inverting input terminals of the operational amplifiers 311A and 311B, and the Q/V amplifiers 31A and 31B convert the input charges into voltages whose polarities are inverted with reference to the reference voltage V_{ref}. The signals output from the respective output terminals of the operational amplifiers 311A and 311B are the signals S1O and S2O.

As illustrated in FIG. 5, the in-phase feedback circuit 34 includes resistors 341 and 342 and capacitors 343A and 343B. The resistors 341 and 342 are connected in series between outputs of the operational amplifiers 311A and 311B. Therefore, a signal VRO obtained by dividing a voltage of a difference between the signals S1O and S2O by the resistors 341 and 342 is output from a node to which the resistors 341 and 342 are connected. When a resistance value of the resistor 341 is equal to a resistance value of the resistor 342, a voltage of the signal VRO with respect to opposite-phase signal components included in the signals S1O and S2O becomes constant at the reference voltage V_{ref}, and a voltage of the signal VRO with respect to in-phase signal components included in the signals S1O and S2O changes following voltages of the in-phase signal components. That is, the resistors 341 and 342 function as an in-phase detection circuit that detects an in-phase signal component without detecting an opposite-phase signal component.

Since physical quantity components included in the signals S1O and S2O have opposite phases, a voltage of a physical quantity component included in the signal VRO is constant at the reference voltage V_{ref}. On the other hand, when the physical quantity detection element 100 resonates due to environmental vibration or the like, resonance components included in the signals S1O and S2O are in phase, and the voltage of a resonance component included in the signal VRO changes in accordance with the voltages of the resonance components. Therefore, by feeding back the signal VRO as a feedback signal FBO to inverting input terminals of the operational amplifiers 311A and 311B via the capacitors 343A and 343B, respectively, the resonance components can be reduced without reducing the physical quantity components included in the signals S1O and S2O.

However, since electrostatic leakage components and vibration leakage components included in the signals S1O and S2O are also in-phase, the electrostatic leakage components and the vibration leakage components are also detected by the resistors 341 and 342, and thus the electrostatic leakage components and the vibration leakage components included in the signals S1O and S2O are also reduced. As a result, when the electrostatic leakage components or the vibration leakage components included in the signals S1O and S2O become minute, the electrostatic leakage detection signal QAO and the vibration leakage detection signal VAO are not output. Therefore, the feedback signal FBO is set to an appropriate voltage level such that the voltages of the signals S1O and S2O are not saturated by the resonance components and the electrostatic leakage components and the vibration leakage components included in the signals S1O and S2O are equal to or higher than a minimum voltage level required for failure diagnosis.

### 1-5. Operation and Effect

In the physical quantity detection device 1 according to the first embodiment, in the circuit device 200, since the in-phase feedback circuit 34 outputs, to the Q/V amplifiers 31A and 31B, the feedback signal FBO based on unnecessary in-phase signal components included in the signals S1O and S2O output from the Q/V amplifiers 31A and 31B, the unnecessary in-phase signal components, such as resonance components input to the Q/V amplifiers 31A and 31B, are reduced. On the other hand, the first and second physical quantity components of opposite phases input to the Q/V amplifiers 31A and 31B are not reduced, and the physical quantity detection signal SDO based on a differentially amplified signal of the first and second physical quantity components is output. Therefore, according to the physical quantity detection device 1 of the first embodiment, since the sensitivity can be improved by narrowing a range of the outputs of the Q/V amplifiers 31A and 31B, a physical quantity can be detected with high accuracy.

Furthermore, in the physical quantity detection device 1 according to the first embodiment, in the circuit device 200, the Q/V amplifiers 31A and 31B also receive the electrostatic leakage components and the vibration leakage components of the same phase required for failure diagnosis, but by appropriately setting a voltage level of the feedback signal FBO, the electrostatic leakage components and the vibration leakage components included in the signals S1O and S2O can be made equal to or higher than a minimum voltage level required for the failure diagnosis while preventing the voltages of the signals S1O and S2O of the Q/V amplifiers 31A and 31B from being saturated by unnecessary in-phase signal components, such as resonance components.

### 2. Second Embodiment

Hereinafter, in a second embodiment, components similar to those in the first embodiment are denoted by the same reference numerals, descriptions overlapping those in the first embodiment will be omitted or simplified, and contents different from those in the first embodiment will be mainly described.

A functional block diagram of a physical quantity detection device 1 according to the second embodiment is the same as that in FIG. 1, and therefore, the illustration and description thereof will be omitted. In addition, since configurations of a physical quantity detection element 100, a drive circuit 20, and a detection circuit 30 in the second embodiment are the same as those in FIGS. 2, 3, and 4, respectively, the illustration and description thereof will be omitted. However, in the physical quantity detection device 1 of the second embodiment, a configuration of an in-phase feedback circuit 34 included in the detection circuit 30 is different from that of the first embodiment.

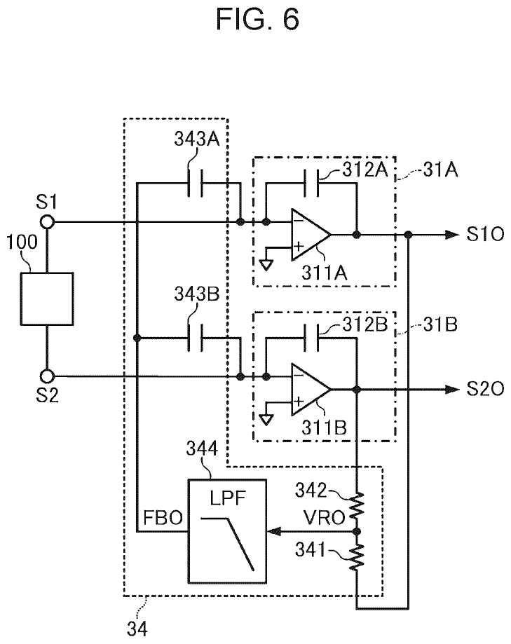

FIG. 6 is a diagram illustrating an example of a configuration of the in-phase feedback circuit 34 according to the second embodiment. The in-phase feedback circuit 34 illustrated in FIG. 6 includes resistors 341 and 342, capacitors 343A and 343B, and a low-pass filter 344. The low-pass filter 344 receives a signal VRO, which is a detection signal of an in-phase signal component, and outputs a feedback signal FBO. In a case where a frequency of a resonance component is lower than a frequency of an electrostatic leakage component and a frequency of a vibration leakage component, the low-pass filter 344 passes the resonance component included in the signal VRO and attenuates the electrostatic leakage component and the vibration leakage component. Then, the feedback signal FBO output from the low-pass filter 344 is fed back to inverting input terminals of operational amplifiers 311A and 311B via the capacitors 343A and 343B. As described above, when the frequency of the resonance component is lower than the frequency of the electrostatic leakage component and the frequency of the vibration leakage component, the in-phase feedback circuit 34 illustrated in FIG. 6 can reduce the electrostatic leakage component and the vibration leakage component included in the feedback signal FBO by the low-pass filter 344. As a result, the resonance component can be reduced without reducing electrostatic leakage components and vibration leakage components included in the output signals S1O and S2O of Q/V amplifiers 31A and 31B as much as possible. Note that, as the low-pass filter 344, a small-sized active filter capable of adjusting a gain of a signal is desirable, but a passive filter is also applicable.

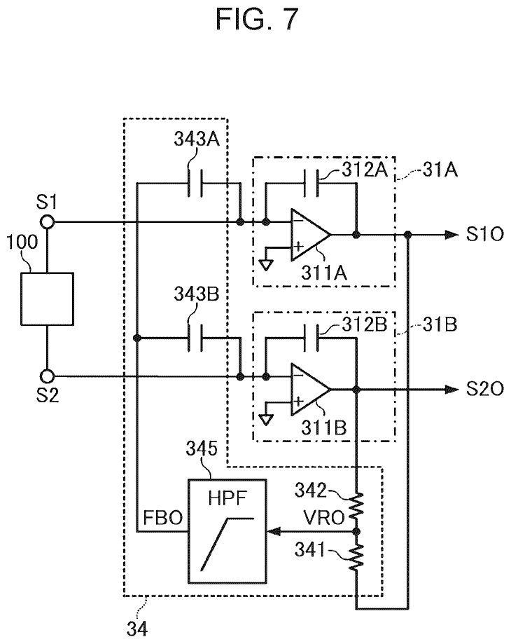

FIG. 7 is a diagram illustrating another example of a configuration of the in-phase feedback circuit 34 according to the second embodiment. The in-phase feedback circuit 34 illustrated in FIG. 7 includes resistors 341 and 342, capacitors 343A and 343B, and a high-pass filter 345. The high-pass filter 345 receives a signal VRO, which is a detection signal of an in-phase signal component, and outputs a feedback signal FBO. In a case where a frequency of a resonance component is higher than a frequency of an electrostatic leakage component and a frequency of a vibration leakage component, the high-pass filter 345 passes the resonance component included in the signal VRO and attenuates the electrostatic leakage component and the vibration leakage component. The feedback signal FBO output from the high-pass filter 345 is fed back to inverting input terminals of operational amplifiers 311A and 311B via the capacitors 343A and 343B. As described above, when the frequency of the resonance component is higher than the frequency of the electrostatic leakage component and the frequency of the vibration leakage component, the in-phase feedback circuit 34 illustrated in FIG. 7 can reduce the electrostatic leakage component and the vibration leakage component included in the feedback signal FBO by the high-pass filter 345. As a result, the resonance component can be reduced without reducing electrostatic leakage components and vibration leakage components included in the output signals S1O and S2O of Q/V amplifiers 31A and 31B as much as possible. As the high-pass filter 345, a small-sized active filter capable of adjusting a gain of a signal is desirable, but a passive filter is also applicable.

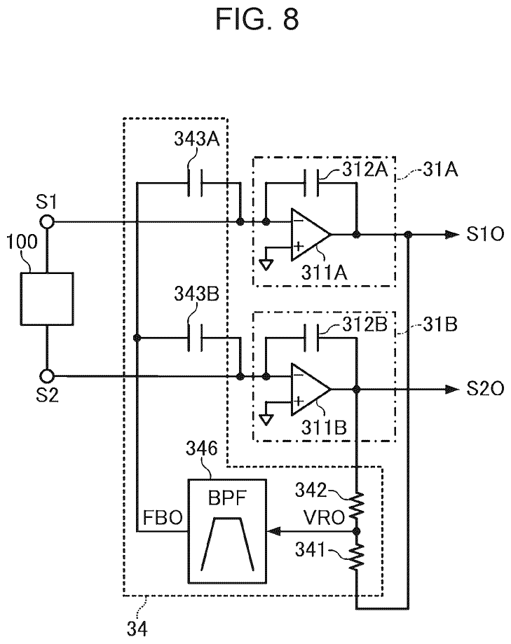

FIG. 8 is a diagram illustrating another example of a configuration of the in-phase feedback circuit 34 according to the second embodiment. The in-phase feedback circuit 34 illustrated in FIG. 8 includes resistors 341 and 342, capacitors 343A and 343B, and a band-pass filter 346. The band-pass filter 346 receives a signal VRO which is a detection signal of an in-phase signal component, and outputs a feedback signal FBO. In a case where a frequency of a resonance component is different from a frequency of an electrostatic leakage component and a frequency of a vibration leakage component, the band-pass filter 346 passes the resonance component included in the signal VRO and attenuates the electrostatic leakage component and the vibration leakage component. The feedback signal FBO output from the band-pass filter 346 is fed back to inverting input terminals of operational amplifiers 311A and 311B via the capacitors 343A and 343B. As described above, when the frequency of the resonance component is different from the frequency of the electrostatic leakage component and the frequency of the vibration leakage component, the in-phase feedback circuit 34 illustrated in FIG. 8 can reduce the electrostatic leakage component and the vibration leakage component included in the feedback signal FBO by the band-pass filter 346. As a result, the resonance component can be reduced without reducing electrostatic leakage components and vibration leakage components included in the output signals S1O and S2O of Q/V amplifiers 31A and 31B as much as possible. Note that, as the band-pass filter 346, a small-sized active filter capable of adjusting a gain of a signal is desirable, but a passive filter is also applicable.

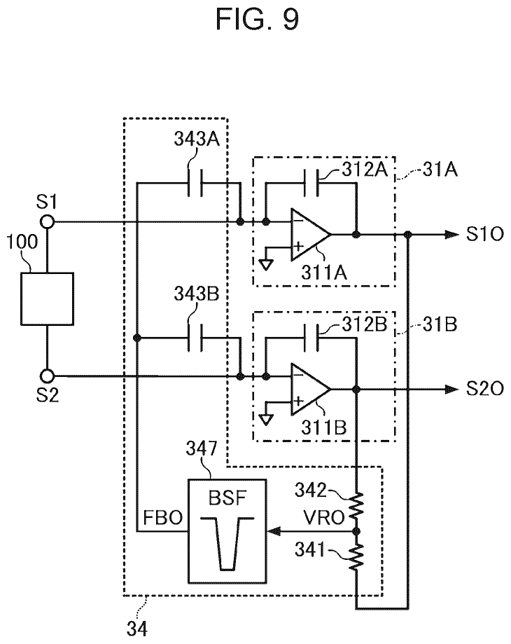

FIG. 9 is a diagram illustrating another example of a configuration of the in-phase feedback circuit 34 according to the second embodiment. The in-phase feedback circuit 34 illustrated in FIG. 9 includes resistors 341 and 342, capacitors 343A and 343B, and a band-stop filter 347. The band-stop filter 347 receives a signal VRO, which is a detection signal of an in-phase signal component, and outputs a feedback signal FBO. When a frequency of a resonance component is different from a frequency of an electrostatic leakage component and a frequency of a vibration leakage component, the band-stop filter 347 passes the resonance component included in the signal VRO and attenuates the electrostatic leakage component and the vibration leakage component. The feedback signal FBO output from the band-stop filter 347 is fed back to inverting input terminals of operational amplifiers 311A and 311B via the capacitors 343A and 343B. As described above, when the frequency of the resonance component is different from the frequency of the electrostatic leakage component and the frequency of the vibration leakage component, the in-phase feedback circuit 34 illustrated in FIG. 9 can reduce the electrostatic leakage component and the vibration leakage component included in the feedback signal FBO by the band-stop filter 347. As a result, the resonance component can be reduced without reducing electrostatic leakage components and vibration leakage components included in output signals S1O and S2O of Q/V amplifiers 31A and 31B as much as possible. Note that, as the band-stop filter 347, a small-sized active filter capable of adjusting a gain of a signal is desirable, but a passive filter is also applicable.

Note that, in a case where the frequency of the electrostatic leakage component or the frequency of the vibration leakage component is close to the frequency of the resonance component, the electrostatic leakage component and the vibration leakage component may be insufficiently attenuated by the low-pass filter 344, the high-pass filter 345, the band-pass filter 346, or the band-stop filter 347. Therefore, gains of the individual filters are set to appropriate values so that the voltages of the signals S1O and S2O are not saturated by the resonance component and the electrostatic leakage component and the vibration leakage component included in the signals S1O and S2O are equal to or higher than the minimum voltage level required for the failure diagnosis. The gains of the individual filters may be fixed values, or the gains of the individual filters may be variably set in a register of a storage 80 from the outside of the circuit device 200.

Other configurations of the physical quantity detection device 1 of the second embodiment are the same as those of the physical quantity detection device 1 of the first embodiment, and thus a description thereof will be omitted.

According to the physical quantity detection device 1 of the second embodiment described above, in the circuit device 200, the in-phase feedback circuit 34 can output the feedback signal FBO by passing a detection signal of an unnecessary in-phase signal component and attenuating a detection signal of a necessary in-phase signal component using the filter of an appropriate type and an appropriate gain corresponding to the relationship between a frequency and intensity of the unnecessary in-phase signal component, such as a resonance component and a frequency and intensity of a necessary in-phase signal component, such as an electrostatic leakage component and a vibration leakage component. Therefore, according to the physical quantity detection device 1 of the second embodiment, it is possible to reduce unnecessary in-phase signal components included in the signals S1O and S2O output from the Q/V amplifiers 31A and 31B and to maintain necessary in-phase signal components. In addition, according to the physical quantity detection device 1 of the second embodiment, the same effects as those of the physical quantity detection device 1 of the first embodiment are obtained.

### 3. Third Embodiment

Hereinafter, in a third embodiment, components similar to those in the first embodiment or the second embodiment are denoted by the same reference numerals, descriptions overlapping those in the first embodiment or the second embodiment will be omitted or simplified, and contents different from those in the first and second embodiments will be mainly described.

A functional block diagram of a physical quantity detection device 1 according to the third embodiment is the same as that in FIG. 1, and therefore, the illustration and description thereof will be omitted. In addition, since configurations of a physical quantity detection element 100, a drive circuit 20, and a detection circuit 30 in the third embodiment are the same as those in FIGS. 2, 3, and 4, respectively, the illustration and description thereof will be omitted. However, in the physical quantity detection device 1 of the third embodiment, a configuration of an in-phase feedback circuit 34 included in the detection circuit 30 is different from those of the first and second embodiments.

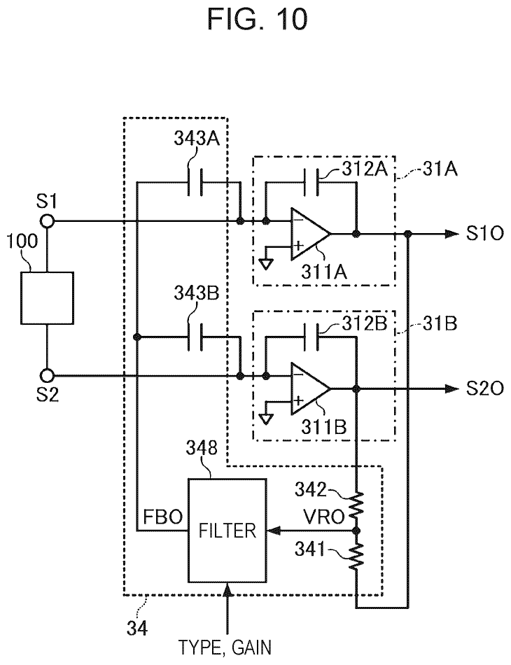

FIG. 10 is a diagram illustrating an example of a configuration of the in-phase feedback circuit 34 according to the third embodiment. The in-phase feedback circuit 34 illustrated in FIG. 10 includes resistors 341 and 342, capacitors 343A and 343B, and a filter circuit 348. The filter circuit 348 receives a signal VRO, which is a detection signal of an in-phase signal component, and outputs a feedback signal FBO. The feedback signal FBO output from the filter circuit 348 is fed back to inverting input terminals of operational amplifiers 311A and 311B via the capacitors 343A and 343B.

In this embodiment, a type and a gain of the filter circuit 348 can be set from the outside of the circuit device 200. For example, the type and the gain of the filter circuit 348 are set in a register included in a storage 80 from the outside of the circuit device 200.

The type of the filter circuit 348 can be set to, for example, a low-pass filter, a high-pass filter, a band-pass filter, or a band-stop filter. In order for the filter circuit 348 to pass a resonance component included in the signal VRO and attenuate an electrostatic leakage component and a vibration leakage component, for example, when a frequency of the resonance component is lower than a frequency of the electrostatic leakage component and a frequency of the vibration leakage component, the type of the filter circuit 348 may be set to a low-pass filter. In addition, in a case where the frequency of the resonance component is higher than the frequency of the electrostatic leakage component and the frequency of the vibration leakage component, the type of the filter circuit 348 may be set to a high-pass filter. In addition, when the frequency of the resonance component is different from the frequency of the electrostatic leakage component and the frequency of the vibration leakage component, the type of the filter circuit 348 may be set to a band-pass filter or a band-stop filter.

In addition, the gain of the filter circuit 348 is set to an appropriate value such that voltages of signals S1O and S2O are not saturated by the resonance component and electrostatic leakage components or vibration leakage components included in the signals S1O and S2O are equal to or higher than the minimum voltage level required for the failure diagnosis. For example, the type and the gain of the filter circuit 348 are set variable in a register included in a storage 80 from the outside of the circuit device 200.

Since other configurations of the physical quantity detection device 1 of the third embodiment are the same as those of the physical quantity detection device 1 of the first embodiment, the description thereof will be omitted.

According to the physical quantity detection device 1 of the third embodiment described above, in the circuit device 200, the type and the gain of the filter circuit 348 can be set from the outside in accordance with the relationship between a frequency and intensity of an unnecessary in-phase signal component, such as a resonance component, and a frequency and intensity of a necessary in-phase signal component, such as an electrostatic leakage component or a vibration leakage component. As a result, the filter circuit 348 can output the feedback signal FBO by passing a detection signal of the unnecessary in-phase signal component and attenuating a detection signal of the necessary in-phase signal component. Therefore, according to the physical quantity detection device 1 of the third embodiment, it is possible to reduce unnecessary in-phase signal components included in the signals S1O and S2O output from the Q/V amplifiers 31A and 31B and to maintain necessary in-phase signal components. In addition, according to the physical quantity detection device 1 of the third embodiment, the same effects as those of the physical quantity detection device 1 of the first embodiment are obtained.

### 4. Fourth Embodiment

Hereinafter, in a fourth embodiment, the same reference numerals are given to the same components as those in any of the first embodiment to the third embodiment, the description overlapping with any of the first embodiment to the third embodiment will be omitted or simplified, and the content different from any of the first embodiment to the third embodiment will be mainly described.

A functional block diagram of a physical quantity detection device 1 according to the fourth embodiment is the same as that in FIG. 1, and therefore, the illustration and description thereof will be omitted. In addition, since configurations of a physical quantity detection element 100, a drive circuit 20, and a detection circuit 30 in the fourth embodiment are the same as those in FIGS. 2, 3, and 4, respectively, the illustration and description thereof will be omitted. However, in the physical quantity detection device 1 of the fourth embodiment, a configuration of an in-phase feedback circuit 34 included in the detection circuit 30 is different from those of the first to third embodiments.

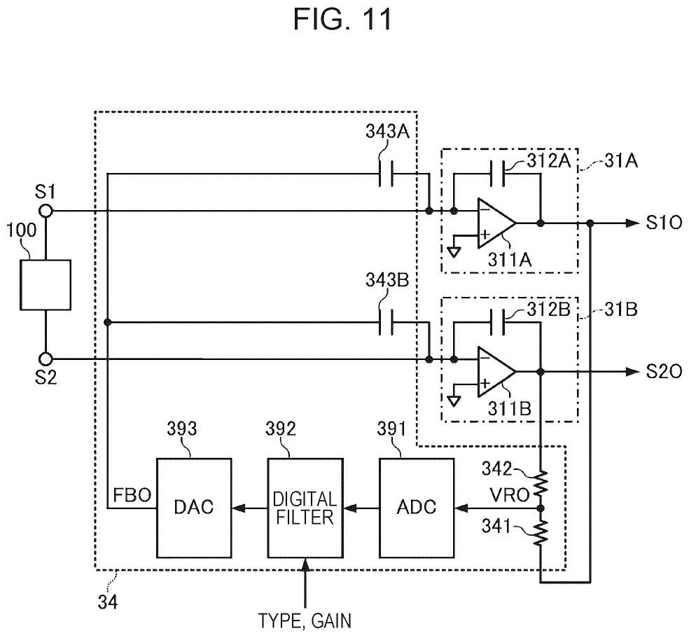

FIG. 11 is a diagram illustrating an example of a configuration of the in-phase feedback circuit 34 according to the fourth embodiment. The in-phase feedback circuit 34 illustrated in FIG. 11 includes resistors 341 and 342, capacitors 343A and 343B, an A/D conversion circuit 391, a digital filter 392, and a D/A conversion circuit 393.

The A/D conversion circuit 391 converts a signal VRO, which is the detection signal of an in-phase signal component, into a digital signal. The digital signal output from the A/D conversion circuit 391 is input to the digital filter 392. The D/A conversion circuit 393 converts a signal output from the digital filter 392 into a feedback signal FBO which is an analog signal. The feedback signal FBO output from the D/A conversion circuit 393 is fed back to inverting input terminals of the operational amplifiers 311A and 311B via the capacitors 343A and 343B.

The digital filter 392 passes a resonance component included in the digital signal output from the A/D conversion circuit 391 and attenuates an electrostatic leakage component and a vibration leakage component. For example, in a case where a frequency of the resonance component is lower than a frequency of the electrostatic leakage component and a frequency of the vibration leakage component, the digital filter 392 may be a low-pass filter. Furthermore, in a case where a frequency of the resonance component is higher than a frequency of the electrostatic leakage component and a frequency of the vibration leakage component, the digital filter 392 may be a high-pass filter. In addition, in a case where a frequency of the resonance component is different from a frequency of the electrostatic leakage component and a frequency of the vibration leakage component, the digital filter 392 may be a band-pass filter or a band-stop filter.

In addition, a gain of the digital filter 392 is set to an appropriate value such that voltages of signals S1O and S2O are not saturated by the resonance component and electrostatic leakage components or vibration leakage components included in the signals S1O and S2O are equal to or higher than the minimum voltage level required for the failure diagnosis.

Note that the type of the digital filter 392 may be variably set to a low-pass filter, a high-pass filter, a band-pass filter, or a band-stop filter. Furthermore, the gain of the digital filter 392 may be variably set. For example, the type and the gain of the digital filter 392 may be set in a register included in a storage 80 from the outside of the circuit device 200.

Since other configurations of the physical quantity detection device 1 of the fourth embodiment are the same as those of the physical quantity detection device 1 of the first embodiment, the description thereof will be omitted.

In the physical quantity detection device 1 according to the fourth embodiment described above, in the circuit device 200, the digital filter 392 which can be realized with a circuit area smaller than that of the analog filter can output the feedback signal FBO by passing a detection signal of the unnecessary in-phase signal component, such as the resonance component, and attenuating a detection signal of the necessary in-phase signal component, such as the electrostatic leakage component or the vibration leakage component. Therefore, according to the physical quantity detection device 1 of the fourth embodiment, it is possible to reduce unnecessary in-phase signal components included in the signals S1O and S2O output from the Q/V amplifiers 31A and 31B and to maintain necessary in-phase signal components with a relatively small circuit area. In addition, according to the physical quantity detection device 1 of the fourth embodiment, the same effects as those of the physical quantity detection device 1 of the first embodiment are obtained.

### 5. Modification Example

The present disclosure is not limited to the embodiments, and various modifications may be made within the scope of the gist of the present disclosure.

For example, in each of the embodiments described above, the physical quantity detection device 1 includes the physical quantity detection element 100 that detects an angular velocity as a physical quantity, but may include a physical quantity detection element that detects a physical quantity other than an angular velocity. For example, the physical quantity detection device 1 may include a physical quantity detection element that detects a physical quantity, such as an acceleration, an angular acceleration, a velocity, or a force.

In each of the above-described embodiments, the physical quantity detection device 1 includes one physical quantity detection element, but may include a plurality of physical quantity detection elements. For example, the physical quantity detection device 1 may include a plurality of physical quantity detection elements, and each of the plurality of physical quantity detection elements may detect a physical quantity using any one of two or more axes orthogonal to each other as a detection axis. Furthermore, for example, the physical quantity detection device 1 may include a plurality of physical quantity detection elements, and each of the plurality of physical quantity detection elements may detect any one of a plurality of types of physical quantities, such as an angular velocity, an acceleration, an angular acceleration, a velocity, and a force. That is, the physical quantity detection device 1 may be a composite sensor.

In addition, in each of the embodiments described above, an example in which a resonator element of the physical quantity detection element 100 is a double-T type quartz crystal resonator element has been described, but the resonator element of the physical quantity detection element which detects various physical quantities may be, for example, a tuning fork type or a comb tooth type, or may be a vibrating reed type having a triangular prism shape, a quadrangular prism shape, a cylindrical shape, or the like. Furthermore, as the material of the resonator element of the physical quantity detection element, instead of quartz crystal (SiO₂), for example, a piezoelectric material, such as piezoelectric single crystal, such as lithium tantalate (LiTaO₃) or lithium niobate (LiNbO₃), or piezoelectric ceramic, such as lead zirconate titanate (PZT), may be used, or a silicon semiconductor may be used. For example, the resonator element of the physical quantity detection element may have a structure in which a piezoelectric thin film made of zinc oxide (ZnO), aluminum nitride (AlN), or the like and interposed between drive electrodes is disposed on a portion of a surface of a silicon semiconductor. For example, the physical quantity detection element may be a MEMS element. MEMS is an abbreviation for Micro Electro Mechanical Systems.

Furthermore, in each of the embodiments described above, the piezoelectric physical quantity detection element is exemplified, but the physical quantity detection element which detects various physical quantities is not limited to the piezoelectric element, and may be an electrostatic capacitance type element, an electrodynamic type element, an eddy current type element, an optical type element, a strain gauge type element, or the like. Moreover, the detection method of the physical quantity detection element is not limited to the vibration method, and may be, for example, an optical method, a rotation method, or a fluid method.

The above-described embodiments and modifications are merely examples, and the present disclosure is not limited thereto. For example, each of the embodiments and each of the modifications may be combined as appropriate.

The present disclosure includes configurations that are substantially the same as the configurations described in the embodiments. For example, the present disclosure includes a configuration having the same functions, methods, and results as those described in the embodiments, or a configuration having the same purposes and effects as those described in the embodiments. Furthermore, the present disclosure includes configurations in which non-essential portions of the configurations described in the embodiments are replaced. In addition, the present disclosure includes configurations that provide the same effects as the configurations described in the embodiments or includes configurations that can achieve the same purposes as the configurations described in the embodiments. Moreover, the present disclosure includes configurations in which known technologies are added to the configurations described in the embodiments.

The following contents are derived from the above-described embodiments and modifications.

A circuit device according to an aspect includes a physical quantity detection signal outputting circuit, including a first amplifier that receives a first signal output from a physical quantity detection element detecting a physical quantity and outputs a first amplified signal obtained by amplifying the first signal, a second amplifier that receives a second signal output from the physical quantity detection element and outputs a second amplified signal obtained by amplifying the second signal, and a differential amplifier circuit that outputs a differential amplified signal obtained by amplifying a difference between the first amplified signal and the second amplified signal, the physical quantity detection signal outputting circuit outputting a physical quantity detection signal corresponding to the physical quantity based on the differential amplified signal, and an in-phase feedback circuit that detects an in-phase signal component included in the first amplified signal and the second amplified signal, and outputs a feedback signal based on a detection signal of the in-phase signal component to the first amplifier and the second amplifier.

In the circuit device, since the in-phase feedback circuit outputs the feedback signal based on the in-phase signal component included in the first amplified signal and the second amplified signal to the first amplifier and the second amplifier, the in-phase signal component input to the first amplifier and the second amplifier is reduced. On the other hand, opposite-phase signal components input to the first amplifier and the second amplifier are not reduced, and a physical quantity detection signal based on a differential amplified signal of the opposite-phase signal component is output. Therefore, according to the circuit device, since the sensitivity can be increased by narrowing output ranges of the first amplifier and the second amplifier, the physical quantity can be detected with high accuracy.

In the aspect of the circuit device, the in-phase feedback circuit may include a low-pass filter to which the detection signal of the in-phase signal component is input and which outputs the feedback signal.

In the circuit device, when the first amplified signal and the second amplified signal include necessary in-phase signal components having frequencies higher than frequencies of unnecessary in-phase signal components, the low-pass filter allows detection signals of the unnecessary in-phase signal components to pass and attenuates detection signals of the necessary in-phase signal components so as to output a feedback signal. Therefore, according to the circuit device, it is possible to reduce the unnecessary in-phase signal components included in the first amplified signal and the second amplified signal and to maintain the necessary in-phase signal components.

In the aspect of the circuit device, the in-phase feedback circuit may include a high-pass filter to which the detection signal of the in-phase signal component is input and which outputs the feedback signal.

In the circuit device, when the first amplified signal and the second amplified signal include the necessary in-phase signal components having frequencies lower than frequencies of the unnecessary in-phase signal components, the high-pass filter allows detection signals of the unnecessary in-phase signal components to pass and attenuates detection signals of the necessary in-phase signal components so as to output a feedback signal. Therefore, according to the circuit device, it is possible to reduce the unnecessary in-phase signal components included in the first amplified signal and the second amplified signal and to maintain the necessary in-phase signal components.

In the aspect of the circuit device, the in-phase feedback circuit may include a band-pass filter to which the detection signal of the in-phase signal component is input and which outputs the feedback signal.

In the circuit device, when the first amplified signal and the second amplified signal include the necessary in-phase signal components having frequencies different from frequencies of the unnecessary in-phase signal components, the band-pass filter allows detection signals of the unnecessary in-phase signal components to pass and attenuates detection signals of the necessary in-phase signal components so as to output a feedback signal. Therefore, according to the circuit device, it is possible to reduce the unnecessary in-phase signal components included in the first amplified signal and the second amplified signal and to maintain the necessary in-phase signal components.

In one aspect of the circuit device, the in-phase feedback circuit may include a band-stop filter to which the detection signal of the in-phase signal component is input and which outputs the feedback signal.

In the circuit device, when the first amplified signal and the second amplified signal include the necessary in-phase signal components having frequencies different from frequencies of the unnecessary in-phase signal components, the band-stop filter allows detection signals of the unnecessary in-phase signal components to pass and attenuates detection signals of the necessary in-phase signal components so as to output a feedback signal. Therefore, according to the circuit device, it is possible to reduce the unnecessary in-phase signal components included in the first amplified signal and the second amplified signal and to maintain the necessary in-phase signal components.

In the aspect of the circuit device, the in-phase feedback circuit may include a filter circuit to which the detection signal of the in-phase signal component is input and which outputs the feedback signal, and a type and a gain of the filter circuit may be set from the outside.

In this circuit device, when the first amplified signal and the second amplified signal include not only the unnecessary in-phase signal components but also the necessary in-phase signal components, the type and the gain of the filter circuit can be set from the outside in accordance with the relationship between the frequencies and intensities of the unnecessary in-phase signal components and the frequencies and intensities of the necessary in-phase signal components. As a result, the filter circuit allows the detection signals of the unnecessary in-phase signal components to pass and attenuates the detection signals of the necessary in-phase signal components so as to output the feedback signal. Therefore, according to the circuit device, it is possible to reduce the unnecessary in-phase signal components included in the first amplified signal and the second amplified signal and to maintain the necessary in-phase signal components.

In the aspect of the circuit device, the in-phase feedback circuit may include an A/D conversion circuit that converts the detection signal of the in-phase signal component into a digital signal, a digital filter to which the digital signal output from the A/D conversion circuit is input, and a D/A conversion circuit that converts a signal output from the digital filter into the feedback signal that is an analog signal.

In the circuit device, when the first amplified signal and the second amplified signal include not only the unnecessary in-phase signal components but also the necessary in-phase signal components, the digital filter that can be realized with a circuit area smaller than that of the analog filter allows the detection signals of the unnecessary in-phase signal components to pass and attenuates the detection signals of the necessary in-phase signal components so as to output a feedback signal. Therefore, according to the circuit device, it is possible to reduce the unnecessary in-phase signal components included in the first amplified signal and the second amplified signal and to maintain the necessary in-phase signal components with the relatively small circuit area.

In the aspect of the circuit device, the circuit device may further include a failure diagnostic signal outputting circuit including an adder circuit that outputs a signal obtained by adding the first amplified signal and the second amplified signal. The failure diagnostic signal outputting circuit may output a failure diagnostic signal based on the signal output from the adder circuit.

According to the circuit device, by appropriately setting a voltage level of the feedback signal, it is possible to set the necessary in-phase signal components included in the first amplified signals and the second amplified signals to be equal to or higher than a minimum voltage level required for failure diagnosis while preventing output voltages of the first amplified signal and the second amplified signal from being saturated by the unnecessary in-phase signal components.

One aspect of a physical quantity detection device according to the present disclosure includes one of the aspects of the circuit device and the physical quantity detection element.

In the physical quantity detection device, in the circuit device, the in-phase feedback circuit outputs the feedback signal based on the in-phase signal components included in the first amplified signal and the second amplified signal to the first amplifier and the second amplifier, and thus the in-phase signal components input to the first amplifier and the second amplifier are reduced. On the other hand, opposite-phase signal components input to the first amplifier and the second amplifier are not reduced, and a physical quantity detection signal based on a differential amplified signal of the opposite-phase signal component is output. Therefore, according to the physical quantity detection device, since the sensitivity can be increased by narrowing output ranges of the first amplifier and the second amplifier, the physical quantity can be detected with high accuracy.

What is claimed is:

1. A circuit device comprising:
a physical quantity detection signal outputting circuit, including
a first amplifier that receives a first signal output from a physical quantity detection element detecting a physical quantity and outputs a first amplified signal obtained by amplifying the first signal,
a second amplifier that receives a second signal output from the physical quantity detection element and outputs a second amplified signal obtained by amplifying the second signal, and
a differential amplifier circuit that outputs a differential amplified signal obtained by amplifying a difference between the first amplified signal and the second amplified signal,
the physical quantity detection signal outputting circuit outputting a physical quantity detection signal corresponding to the physical quantity based on the differential amplified signal; and
an in-phase feedback circuit that detects an in-phase signal component included in the first amplified signal and the second amplified signal, and outputs a feedback signal based on a detection signal of the in-phase signal component to the first amplifier and the second amplifier.

2. The circuit device according to claim 1, wherein
the in-phase feedback circuit includes
a low-pass filter to which the detection signal of the in-phase signal component is input and which outputs the feedback signal.

3. The circuit device according to claim 1, wherein
the in-phase feedback circuit includes
a high-pass filter to which the detection signal of the in-phase signal component is input and which outputs the feedback signal.

4. The circuit device according to claim 1, wherein
the in-phase feedback circuit includes
a band-pass filter to which the detection signal of the in-phase signal component is input and which outputs the feedback signal.

5. The circuit device according to claim 1, wherein
the in-phase feedback circuit includes
a band-stop filter to which the detection signal of the in-phase signal component is input and which outputs the feedback signal.

6. The circuit device according to claim 1, wherein
the in-phase feedback circuit includes
a filter circuit to which the detection signal of the in-phase signal component is input and which outputs the feedback signal, and
a type and a gain of the filter circuit is settable from the outside.

7. The circuit device according to claim 1, wherein
the in-phase feedback circuit includes
an A/D conversion circuit that converts the detection signal of the in-phase signal component into a digital signal,
a digital filter to which the digital signal output from the A/D conversion circuit is input, and
a D/A conversion circuit that converts a signal output from the digital filter into the feedback signal that is an analog signal.

8. The circuit device according to claim 1, further comprising:
a failure diagnostic signal outputting circuit including an adder circuit that outputs a signal obtained by adding the first amplified signal and the second amplified signal, wherein
the failure diagnostic signal outputting circuit outputs a failure diagnostic signal based on the signal output from the adder circuit.

9. A physical quantity detection device comprising:
the circuit device according to claim 1; and
the physical quantity detection element.
